(19) United States
(12) Patent Application Publication
(10) Pub. No.: US 2017/0256786 A1
(43) Pub. Date: Sep. 7, 2017

(54) LITHIUM SECONDARY ION BATTERY

(71) Applicant: Samsung Electronics Co., Ltd., Suwon-si (KR)

(72) Inventors: Seitaro ITO, Yokohama-city (JP); Yuichi AIHARA, Yokohama-city (JP)

(21) Appl. No.: 15/447,759

(22) Filed: Mar. 2, 2017

(30) Foreign Application Priority Data
Mar. 3, 2016 (JP) 2016-041219
Sep. 9, 2016 (KR) 10-2016-0116575

(51) Int. Cl. H01M 4/136; H01M 4/62; H01M 4/525; H01M 4/58; H01M 4/485; H01M 4/505; H01M 10/0525; H01M 4/131

(52) U.S. Cl. CPC H01M 4/136; H01M 10/0525; H01M 4/624; H01M 4/131; H01M 4/5815; H01M 4/485; H01M 4/505; H01M 4/525; H01M 2004/028

(57) ABSTRACT

A lithium ion secondary battery including: a cathode layer including at least a halogen-containing sulfide catholyte including a sulfide catholyte and a halide, and a conducting material; a solid electrolyte layer; and an anode layer, wherein the halogen-containing sulfide catholyte in the cathode layer can be reversibly oxidized and reduced.

### CROSS-REFERENCE TO RELATED APPLICATIONS

This application claims priority to and the benefit of Japanese Patent Application No. 2016-041219, filed on Mar. 3, 2016, in the Japanese Intellectual Property Office, and Korean Patent Application No. 10-2016-0116575, filed on Sep. 9, 2016, in the Korean Intellectual Property Office, and all the benefits accruing therefrom under 35 U.S.C. §119, the contents of which are incorporated herein in their entirety by reference.

### BACKGROUND

1. Field

This disclosure relates to lithium ion secondary batteries.

2. Description of the Related Art

All-solid lithium ion secondary batteries using a sulfide-based solid electrolyte are recently getting attention. Regarding all-solid lithium ion secondary batteries, studies into the use of sulfide-based solid electrolyte in an electrode layer, in addition to in an electrolyte layer, are being performed. Nonetheless, there remains a need for an improved lithium ion secondary battery.

### SUMMARY

Provided is a lithium ion secondary battery with improved discharge capacity.

Additional aspects will be set forth in part in the description which follows and, in part, will be apparent from the description, or may be learned by practice of the presented embodiments.

According to an aspect of an embodiment, a lithium ion secondary battery includes: a cathode layer including at least a halogen-containing sulfide catholyte including a sulfide catholyte and a halide, and a conducting material; a solid electrolyte layer; and an anode layer, wherein the halogen-containing sulfide catholyte in the cathode layer can be reversibly oxidized and reduced.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 is a schematic cross-sectional view of an embodiment of layers constituting a lithium ion secondary battery;

FIG. 2 shows a graph of voltage (volts vs. Li/Li⁺) versus charge-discharge capacity (milliampere hours per gram, mAh/g) showing results from charge and discharge of a lithium ion secondary battery manufactured according to Example 1;

FIG. 3 shows a graph of charge-discharge capacity (milliampere hours per gram, mAh/g) and coulombic efficiency (percent, %) versus cycle number showing cyclic characteristics of a lithium ion secondary battery manufactured according to Example 1;

FIG. 4 shows a graph of voltage (volts vs. Li/Li⁺) versus charge-discharge capacity (milliampere hours per gram, mAh/g) showing results from charge and discharge of a lithium ion secondary battery manufactured according to Example 2;

FIG. 5 shows a graph of charge-discharge capacity (milliampere hours per gram, mAh/g) and coulombic efficiency (percent, %) versus cycle number showing cyclic characteristics of a lithium ion secondary battery manufactured according to Example 2;

FIG. 6 shows a graph of voltage (volts vs. Li/Li⁺) versus charge-discharge capacity (milliampere hours per gram, mAh/g) showing results from charge and discharge of a lithium ion secondary battery manufactured according to Comparative Example 1;

FIG. 7 shows a graph of charge-discharge capacity (milliampere hours per gram, mAh/g) and coulombic efficiency (percent, %) versus cycle number showing cyclic characteristics of a lithium ion secondary battery manufactured according to Comparative Example 1; and

FIG. 8 shows a graph of voltage (volts vs. Li/Li⁺) versus charge-discharge capacity (milliampere hours per gram, mAh/g) showing results from charge and discharge of lithium ion secondary batteries manufactured according to Example 3 and Comparative Example 2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a lithium ion secondary battery according to an embodiment will be disclosed in further detail.

To prevent a reaction between an anode consisting of an activated metal and an anode external environment, such as ambient humidity or an organic liquid electrolyte, a lithium-ion conductive sulfide can be used as a protective layer for the anode. In an all-solid lithium ion secondary battery using Li₃PS₄, which is a sulfide-based solid electrolyte, Li₃PS₄ is used as a cathode active material to improve energy density. The all-solid lithium ion secondary battery in which Li₃PS₄ is used as a cathode active material may have a greater capacity due to the use of a solid electrolyte as a cathode active material. However, the Li₃PS₄ solid electrolyte used as the cathode active material has a low capacity.

To address this issue, a cathode active material that provides greater capacity is used to improve a charge and discharge capacity and to provide an improved lithium ion secondary battery.

Therefore, embodiments of the present disclosure provide a lithium ion secondary battery including: a cathode layer including at least a conducting material and a halogen-containing sulfide catholyte including a sulfide catholyte and a halide; a solid electrolyte layer; and an anode layer, wherein the halogen-containing sulfide catholyte of the cathode layer shows an oxidation-reduction capacity, i.e., can be reversibly oxidized and reduced.

According to an embodiment, a halogen-containing sulfide catholyte that can be reversibly oxidized and reduced, that is provides a high oxidation-reduction capacity, can act as a cathode active material, and accordingly, the charge and discharge capacity of a lithium ion secondary battery including the same may be improved.

Since the cathode layer further includes a cathode active material other than the halogen-containing sulfide catholyte, the halogen-containing sulfide catholyte may provide a reversible oxidation-reduction potential range that partially or completely overlaps with a reversible oxidation-reduction potential range of the other cathode active material. In this aspect, within the cathode layer, both the halogen-containing sulfide catholyte and a cathode active material undergo an oxidation and reduction reaction, leading to a greater charge and discharge capacity of a cathode active material.

The other cathode active material may have a reversible oxidation-reduction potential range that at least partially overlaps the range of about 1 Volt (V) to about 3.5 V (vs. Li/Li⁺). In this aspect, the charge and discharge capacity of a lithium ion secondary battery may be further improved.

The other cathode active material may comprise sulfur (S), lithium sulfide (Li₂S), vanadium dioxide (V₂O₅), or a combination thereof. In this aspect, the charge and discharge capacity of a lithium ion secondary battery may be further improved.

The sulfide catholyte may comprise a composition of the formula 0.75Li₂S-0.25P₂S₅, and a halide included in the sulfide catholyte may be LiX, wherein X may comprise Cl, Br, I, or a combination thereof. In an embodiment, X is Cl, Br, or I. Accordingly, the lithium ion secondary battery may have a greater charge and discharge capacity, and lithium ion conductivity in an electrolyte layer may be further improved.

The halogen-containing sulfide catholyte may have a composition of the formula aLiX-(100-a)(0.75Li₂S-0.25P₂S₅), wherein 0<a<50, and X may comprise Cl, Br, I, or a combination thereof, and the halide included in the sulfide catholyte may be LiI, and the halogen-containing sulfide catholyte may have a composition of the formula 35LiI-65(0.75Li₂S-0.25P₂S₅). Accordingly, the Li ion secondary battery may have a greater charge and discharge capacity, and a Li ion conductivity in an electrolyte layer may be further improved.

Hereinafter, referring to the attached drawings, embodiments of the present disclosure will be described in further detail. Regarding the detailed description and the drawings, elements having substantially the same functions are denoted by the same element numerals, and the same descriptions will be omitted for clarity.

### 1. Summary of Lithium Ion Secondary Battery

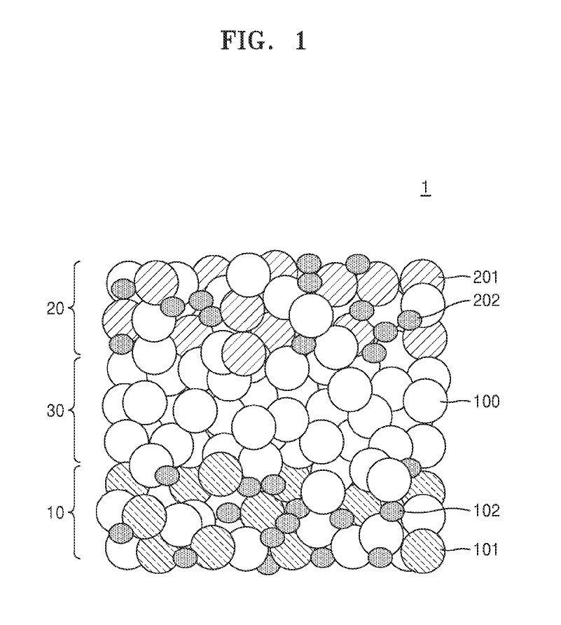

First, referring to FIG. 1, a lithium ion secondary battery according to an embodiment will be described briefly. FIG. 1 is a schematic cross-sectional view of an embodiment of layers constituting a lithium ion secondary battery 1 according to an example embodiment.

Referring to FIG. 1, the lithium ion secondary battery 1 is an all-solid lithium ion secondary battery using a solid electrolyte as an electrolyte.

In detail, the lithium ion secondary battery 1 comprises a cathode layer 10 that includes at least a halogen-containing sulfide catholyte 100 including a sulfide catholyte and a halide, and a cathode-layer conducting material 102. Herein, the halogen-containing sulfide catholyte can be reversibly oxidized and reduced, that is shows an oxidation and reduction capacity in the cathode layer 10. The reversible oxidation and reduction can be at potential of 1 Volt to 3.5 Volts vs. Li/Li⁺ or less, e.g., at about 1V to 3.5V vs. Li/Li⁺. Since the lithium ion secondary battery 1 is charged or discharged within the reversible oxidation and reduction potential range of the halogen-containing sulfide catholyte 100, the halogen-containing sulfide catholyte 100 providing improved oxidation and reduction capacity may perform as a cathode active material. Accordingly, the lithium ion secondary battery 1 may have an improved discharge capacity.

A halogen-containing sulfide catholyte which can be reversibly oxidized and reduced in a lithium ion secondary battery may have the reversible oxidation and reduction potential of 3.5 V (vs. Li/Li⁺) or less. For example, a halogen-containing sulfide catholyte showing an oxidation and reduction capacity in a lithium ion secondary battery may have the reversible oxidation and reduction potential of 3.3 V (vs. Li/Li⁺) or less. For example, a halogen-containing sulfide catholyte showing an oxidation and reduction capacity in a lithium ion secondary battery may have the reversible oxidation and reduction potential of 3.1 V (vs. Li/Li⁺) or less. For example, a halogen-containing sulfide catholyte showing an oxidation and reduction capacity in a lithium ion secondary battery may have the reversible oxidation and reduction potential of 3.0 V (vs. Li/Li⁺) or less. For example, a halogen-containing sulfide catholyte showing an oxidation and reduction capacity in a lithium ion secondary battery may have the reversible oxidation and reduction potential of 2.9 V (vs. Li/Li⁺) or less, e.g., about 1V to about 3.5V vs. Li/Li⁺, about 1.1V to about 3.3V vs. Li/Li⁺, about 1.2V to about 3.1V vs. Li/Li⁺, or about 1.3V to about 3V vs. Li/Li⁺. Within these reversible oxidation and reduction potential ranges of the halogen-containing sulfide catholyte, a lithium ion secondary battery driven in these ranges may have a higher discharge capacity.

In a lithium ion secondary battery, a halogen-containing sulfide catholyte may show a greater discharge capacity than a sulfide catholyte not comprising the halide. For example, the sulfide catholyte may provide a discharge capacity of about 150 mAh/g, and the halogen-containing sulfide catholyte may provide a discharge capacity that is greater than that of the sulfide catholyte. For example, a lithium ion secondary battery including the halogen-containing sulfide catholyte may provide a discharge capacity of 200 mAh/g when being charged to a cut-off voltage of 1.3 V(vs. Li/Li⁺). For example, a lithium ion secondary battery including the halogen-containing sulfide catholyte may provide a discharge capacity of 220 mAh/g or more when being charged to a cut-off voltage of 1.3 V(vs. Li/Li⁺). For example, a lithium ion secondary battery including the halogen-containing sulfide catholyte may provide a discharge capacity of 240 mAh/g or more when being charged to a cut-off voltage of 1.3 V(vs. Li/Li⁺). For example, a lithium ion secondary battery including the halogen-containing sulfide catholyte may provide a discharge capacity of 250 mAh/g when being charged to a cut-off voltage of 1.3 V(vs. Li/Li⁺).

An average particle diameter of the halogen-containing sulfide catholyte in the lithium ion secondary battery may be in the range of about 0.01 μm to about 30 μm, but is not limited thereto. The average particle diameter of the halogen-containing sulfide catholyte may vary depending on characteristics of a battery. For example, the average particle diameter of the halogen-containing sulfide catholyte may be in the range of about 0.1 μm to about 20 μm.

The amount of the halogen-containing sulfide catholyte in the lithium ion secondary battery may be in the range of about 10 weight percent (wt %) to about 95 wt %, based on a total weight of the cathode layer. For example, the amount of the halogen-containing sulfide catholyte in the lithium ion secondary battery may be in the range of about 20 wt % to about 95 wt %, based on a total weight of the cathode layer. The amount of the halogen-containing sulfide catholyte in the lithium ion secondary battery may be in the range of about 30 wt % to about 95 wt %, based on a total weight of the cathode layer. The amount of the halogen-containing sulfide catholyte in the lithium ion secondary battery may be in the range of about 40 wt % to about 95 wt %, based on a total weight of the cathode layer. The amount of the halogen-containing sulfide catholyte in the lithium ion secondary battery may be in the range of about 45 wt % to about 95 wt %, based on a total weight of the cathode layer. The amount of the halogen-containing sulfide catholyte in the lithium ion secondary battery may be in the range of about 50 wt % to about 95 wt %, based on a total weight of the cathode layer. The amount of the halogen-containing sulfide catholyte in the lithium ion secondary battery may be in the range of about 60 wt % to about 95 wt %, based on a total weight of the cathode layer. The amount of the halogen-containing sulfide catholyte in the lithium ion secondary battery may be in the range of about 70 wt % to about 95 wt %, based on a total weight of the cathode layer. The amount of the halogen-containing sulfide catholyte in the lithium ion secondary battery may be in the range of about 80 wt % to about 95 wt %, based on a total weight of the cathode layer. The amount of the halogen-containing sulfide catholyte in the lithium ion secondary battery may be in the range of about 90 wt % to about 95 wt %, based on a total weight of the cathode layer. The halogen-containing sulfide catholyte may perform as an active material in a lithium ion secondary battery. Accordingly, a total amount of an active material in the cathode layer may be increased. An amount of sulfide when used in a solid electrolyte alone as in the related art may differ from that when sulfide is used in a cathode layer.

Regarding a lithium ion secondary battery including the halogen-containing sulfide catholyte, a capacity retention of the lithium ion secondary battery after 50 cycles of charging and discharging in the range of about 1.3 V to about 3.1 V (vs. Li/Li⁺) may be 90% or more. For example, the capacity retention of the lithium ion secondary battery after 50 cycles of charging and discharging in the range of about 1.3 V to about 3.1 V (vs. Li/Li⁺) may be 95% or more. For example, the capacity retention of the lithium ion secondary battery after 50 cycles of charging and discharging in the range of about 1.3 V to about 3.1 V (vs. Li/Li⁺) may be 97% or more. For example, the capacity retention of the lithium ion secondary battery after 50 cycles of charging and discharging in the range of about 1.3 V to about 3.1 V (vs. Li/Li⁺) may be 99% or more. Due to the inclusion of the halogen-containing sulfide catholyte, the manufactured lithium ion secondary battery may provide a higher capacity retention ratio. A charge and discharge capacity of the lithium ion secondary battery after 50 cycles of charging and discharging is obtained by dividing the discharge capacity in the fifth cycle by the discharge capacity in the first cycle and multiplying by 100%.

Regarding a lithium ion secondary battery including the halogen-containing sulfide catholyte, a coulombic efficiency of the lithium ion secondary battery after 50 cycles of charging and discharging in the range of 1.3 V to 3.1 V (vs. Li/Li⁺) may be 90% or more. For example, the coulombic efficiency of the lithium ion secondary battery after 50 cycles of charging and discharging in the range of about 1.3 V to about 3.1 V (vs. Li/Li⁺) may be 95% or more. For example, the Coulombic efficiency of the lithium ion secondary battery after 50 cycles of charging and discharging in the range of about 1.3 V to about 3.1 V (vs. Li/Li⁺) may be 97% or more. For example, the Coulombic efficiency of the lithium ion secondary battery after 50 cycles of charging and discharging in the range of about 1.3 V to about 3.1 V (vs. Li/Li⁺) of the lithium ion secondary battery may be 99% or more. Due to the inclusion of the halogen-containing sulfide catholyte, the manufactured lithium ion secondary battery may provide a greater coulombic efficiency. A coulombic efficiency of the lithium ion secondary battery after 50 cycles of charging and discharging is obtained by dividing the discharge capacity in the fifth cycle by the charge capacity in the fifth cycle and multiplying by 100%.

The lithium ion secondary battery including the halogen-containing sulfide catholyte may not include another cathode active material other than the halogen-containing sulfide catholyte. In an embodiment, the cathode active material of the lithium ion secondary battery including the halogen-containing sulfide catholyte may consist of the halogen-containing sulfide catholyte. That is, although the lithium ion secondary battery comprises the halogen-containing sulfide catholyte as the only cathode active material, the lithium ion secondary battery may be used as a lithium secondary ion battery providing the discharge capacity of 200 mAh/g or more.

In an embodiment, the cathode layer 10 of the lithium ion secondary battery 1 may further include, in addition to the halogen-containing sulfide catholyte 100, another cathode active material 101. Here, the reversible oxidation and reduction potential range of the halogen-containing sulfide catholyte 100 may partially or completely overlap with the reversible oxidation and reduction potential range of the other cathode active material 101. In this structure, during charging and discharging, both the halogen-containing sulfide catholyte 100 and the other cathode active material 101 in the cathode layer 10 may undergo an oxidation and reduction reaction simultaneously, and, accordingly, the charge and discharge capacity of a total cathode active material may be further increased. For example, the reversible oxidation and reduction potential range of the other cathode active material 101 may at least partially overlap the range of about 1 V to about 3.5 V (vs. Li/Li⁺).

The reversible oxidation and reduction potential range of the other cathode active material 101 in the lithium ion secondary battery may be 3.5 V (vs. Li/Li⁺) or less. For example, the reversible oxidation and reduction potential of the other cathode active material 101 in the lithium ion secondary battery 1 may be 3.3 V (vs. Li/Li⁺) or less. For example, the reversible oxidation and reduction potential of the other cathode active material 101 in the lithium ion secondary battery 1 may be 3.1 V (vs. Li/Li⁺) or less. For example, the reversible oxidation and reduction potential of the other cathode active material 101 in the lithium ion secondary battery may be 3.0 V (vs. Li/Li⁺) or less. For example, the reversible oxidation and reduction potential of the other cathode active material 101 in the lithium ion secondary battery 1 may be 2.9 V (vs. Li/Li⁺) or less. For example, the reversible oxidation and reduction potential of the other cathode active material 101 in the lithium ion secondary battery 1 may be in the range of about 1.0 V to about 2.5 V (vs. Li/Li⁺). Within these reversible oxidation and reduction potential ranges of the other cathode active material 101, the lithium ion secondary battery driven in these ranges may have a higher discharge capacity. When the reversible oxidation and reduction potential range of the other cathode active material 101 in the lithium ion secondary battery exceeds 3.5 V (vs. Li/Li⁺), the halogen-containing sulfide catholyte may not be oxidized or reduced in the oxidation and reduction potential range, and accordingly, the discharge capacity of a total cathode active material may not be increased.

In a lithium ion secondary battery, the mixture of a halogen-containing sulfide catholyte and another cathode active material may show a greater discharge capacity than when the other cathode active material is used alone. For example, the mixture of the halogen-containing sulfide catholyte and the other cathode active material may provide a discharge capacity that is greater than that when the other cathode active material is used alone by about 100 mAh/g or more. For example, the mixture of the halogen-containing sulfide catholyte and the other cathode active material may provide a discharge capacity that is greater than that when the other cathode active material is used alone by about 150 mAh/g or more. For example, the mixture of the halogen-containing sulfide catholyte and the other cathode active material may provide a discharge capacity that is greater than that when the other cathode active material is used alone by about 200 mAh/g or more. For example, the mixture of the halogen-containing sulfide catholyte and the other cathode active material may provide a discharge capacity that is greater than that when the other cathode active material is used alone by about 230 mAh/g or more.

For example, the other cathode active material in the lithium ion secondary battery may comprise LiMO₄ (wherein M is Fe, Mn, Ni, or Cu), Li_{4/3}Ti_{5/3}O₄, Bi₂O₃, Bi₂Pb₃O₅, CuO, V₆O₁₃, LiV₆O₁₃, NbSe₃, LiNbSe₃, TiS₂, FeS, FeS₂, CuS, Ni₃S₂, LiTiS₂, LiMoS₂, S, Li₂S, V₂O₅, or a combination thereof. For example, the other cathode active material in the lithium ion secondary battery may be S, Li₂S, or V₂O₅. The reversible oxidation and reduction potential range of the other cathode active material may at least partially overlap with the reversible oxidation and reduction potential range of the halogen-containing sulfide catholyte, and thus, the other cathode active material and the halogen-containing sulfide catholyte may simultaneously undergo an oxidation and reduction reaction, leading to an increase in the discharge capacity of the cathode active material. For example, when the other cathode active material in a lithium ion secondary battery is S, the lithium secondary ion battery may have a discharge capacity of 1,700 mAh/g or more when being charged to cut-off voltage of 1.3 V(vs. Li/Li⁺).

Regarding a lithium secondary ion battery that includes a halogen-containing sulfide catholyte and another cathode active material, a capacity retention of the lithium ion secondary battery after 50 cycles of charging and discharging in the range of about 1.3 V to about 3.1 V (vs. Li/Li⁺) may be 95% or more. For example, the capacity retention of the lithium ion secondary battery after 50 cycles of charging and discharging in the range of about 1.3 V to about 3.1 V (vs. Li/Li⁺) may be 97% or more. For example, the capacity retention of the lithium ion secondary battery after 50 cycles of charging and discharging in the range of about 1.3 V to about 3.1 V (vs. Li/Li⁺) may be 99% or more. Due to the inclusion of the halogen-containing sulfide catholyte and another cathode active material, the manufactured lithium ion secondary battery may provide an improved capacity retention. A charge and discharge capacity of the lithium secondary ion battery after 50 cycles of charging and discharging is obtained by dividing the discharge capacity in the fifth cycle by the discharge capacity in the first cycle and multiplying by 100%.

Regarding a lithium ion secondary battery that includes a halogen-containing sulfide catholyte and another cathode active material, a coulombic efficiency of the lithium secondary ion battery after 50 cycles of charging and discharging in the range of about 1.3 V to about 3.1 V (vs. Li/Li⁺) may be 90% or more. For example, the coulombic efficiency of the lithium secondary ion battery after 50 cycles of charging and discharging in the range of about 1.3 V to about 3.1 V (vs. Li/Li⁺) of the lithium ion secondary battery may be 95% or more. For example, the coulombic efficiency of the lithium secondary ion battery after 50 cycles of charging and discharging in the range of about 1.3 V to about 3.1 V (vs. Li/Li⁺) of the lithium ion secondary battery may be 97% or more. For example, the coulombic efficiency of the lithium secondary ion battery after 50 cycles of charging and discharging in the range of about 1.3 V to about 3.1 V (vs. Li/Li⁺) of the lithium ion secondary battery may be 99% or more. Since the lithium ion secondary battery includes the halogen-containing sulfide catholyte and the other cathode active material, the lithium ion secondary battery may provide increased coulombic efficiency. A coulombic efficiency of the lithium secondary ion battery after 50 cycles of charging and discharging is obtained by dividing the discharge capacity in the fifth cycle by the charge capacity in the fifth cycle and multiplying 100%.

### 2. Structure of Lithium Ion Secondary Battery

A lithium ion secondary battery according to an embodiment of the present disclosure will be described in further detail.

Referring to FIG. 1, the lithium ion secondary battery 1 includes the cathode layer 10, an anode layer 20, and a solid electrolyte layer 30, wherein the solid electrolyte layer 30 is disposed between the cathode layer 10 and the anode layer 20.

### Cathode Layer

The cathode layer 10 may comprise the halogen-containing sulfide catholyte 100, the other cathode active material 101, and the cathode-layer conducting material 102 providing electron-conductivity.

### Halogen-Containing Sulfide Catholyte

The halogen-containing sulfide catholyte 100 may be formed by adding a halide to a sulfide catholyte. The term ‘catholyte’ used herein refers to a compound that performs as a cathode active material showing an oxidation and reduction capacity and shows a lithium ion conductivity in the solid electrolyte layer 30, when the lithium ion secondary battery 1 is driven, that is, when a charge and discharge potential is applied to the lithium ion secondary battery 1.

Examples of the halide include a lithium halide (LiX), a sodium halide (NaX), a C1 to C10 alkyl halide, or a combination thereof. X in these halides indicates, for example, chlorine (Cl), bromine (Br), iodine (I), or a combination thereof. Use of chlorine, bromine, or iodine is mentioned. In an embodiment, the sulfide catholyte, to which halogen is added, may be a sulfide solid electrolyte material, and may comprise Li₂S—P₂S₅, Li₂S—P₂S₅—Li₂O, Li₂S—SiS₂, Li₂S—SiS₂—B₂S₃, Li₂S—B₂S₃, Li₂S—P₂S₅—ZₘSₙ (wherein m and n are each an integer, and Z is Fe, Zn, Ge or Ga), Li₂S—GeS₂, Li₂S—SiS₂—Li₃PS₄, Li₂S—SiS₂—LiₚMO_{q} (wherein p and q are each a positive number, and M is P, Si, Ge, B, Al, Ga, or In) or a combination thereof.

In an embodiment, the halogen-containing sulfide catholyte 100 may include, from among these sulfide solid electrolyte materials, a sulfide solid electrolyte material including sulfur (S), phosphorus (P), or lithium (Li). For example, a sulfide solid electrolyte material including at least Li₂S—P₂S₅ may be used. In an embodiment, the halogen-containing sulfide catholyte 100 may include a material selected from a crystalline material, an amorphous material, and a glass material, in consideration of characteristics of a battery.

When the sulfide solid electrolyte material including Li₂S—P₂S₅ is used for the halogen-containing sulfide catholyte 100, a mixed molar ratio of Li₂S to P₂S₅ may be, for example, 50:50 to 90:10. For example, the sulfide solid electrolyte material may have the composition of the formula pLi₂S-(1-q)5P₂S₅ (0.50≦p≦0.90). In an embodiment, an amorphous sulfide solid electrolyte material having the composition of the formula 0.75Li₂S-0.25P₂S₅ may be used as the halogen-containing sulfide catholyte 100, and a halide may comprise LiX (X may comprise Cl, Br, I, or a combination thereof). Accordingly, the charge and discharge capacity of the lithium ion secondary battery 1 may be further improved, and lithium ion conductivity of the cathode layer 10 may be further increased.

For example, the halogen-containing sulfide catholyte 100 may have the composition of the formula aLiX-(100-a)(0.75Li₂S-0.25P₂S₅) (wherein 0<a<50, and X is Cl, Br, I, or a combination thereof). For example, the halide to be added may be LiI, and the halogen-containing sulfide catholyte 100 may have the composition of the formula 35LiI-65(0.75Li₂S-0.25P₂S₅). When the halogen-containing sulfide catholyte 100 has such a composition, charge and discharge capacity of the lithium ion secondary battery 1 may be further increased, and lithium-ion conductivity of the cathode layer 10 may be further increased.

The halogen-containing sulfide catholyte 100 may consist of, for example, complete-spherical particles or oval spherical particles. A particle diameter of the halogen-containing sulfide catholyte 100 is not particularly limited. For example, an average particle diameter of the halogen-containing sulfide catholyte 100 may be equal to or greater than about 0.01 μm and smaller than or equal to 30 μm, and for example, equal to or greater than about 0.01 μm and smaller than or equal to 20 μm. The term “average particle diameter” refers to the diameter of the number median particle in the particle size distribution of particles obtained by a scattering method or the like, e.g., light scattering, and may be measured with a particle size distribution meter or the like.

In an embodiment, an amount of the halogen-containing sulfide catholyte 100 in the cathode layer 10 may be equal to or greater than about 10 wt %, and smaller than or equal to about 95 wt %, and for example, equal to or greater than about 20 wt % and smaller than or equal to about 90 wt %, based on a total weight of the cathode layer 10.

### Cathode Active Material

The other cathode active material 101 may include an active material that has a higher charge and discharge potential than an anode active material 201 included in the anode layer 20, and that enables intercalation and deintercalation of lithium ions in a reversible manner.

In an embodiment, the other cathode active material 101 may have a reversible oxidation and reduction potential range that at least partially overlap the range of about 1 V to about 3.5 V (vs. Li/Li⁺). The other cathode active material 101 may comprise, for example, LiFePO₄, Li_{4/3}Ti_{5/3}O₄, S, Li₂S, or V₂O₅. The other cathode active material 101 of the lithium ion secondary battery 1 may include sulfur (S), lithium sulfide (Li₂S), or vanadium oxide (V₂O₅), and, for example, S. In an embodiment, the other cathode active material may comprise sulfur (S), lithium sulfide (Li₂S), vanadium oxide (V₂O₅), or a combination thereof.

The other cathode active material 101 may consist of, for example, complete-spherical particles or oval spherical particles. The other cathode active material 101 may have an average particle diameter of, for example, about 0.01 μm to about 50 μm. The term “average particle diameter” refers to the diameter of the number median particle in the particle size distribution of particles obtained by a scattering method or the like, e.g., light scattering, and may be measured with a particle size distribution meter or the like.

In an embodiment, an amount of the other cathode active material 101 in the cathode layer 10 may be equal to or greater than about 10 wt % and smaller than or equal to about 99 wt %, and for example, equal to or greater than about 20 wt % and smaller than or equal to about 90 wt %, based on a total weight of the cathode layer 10.

### Cathode-Layer Conducting Material

The cathode-layer conducting material 102 may provide electron conductivity to the halogen-containing sulfide catholyte 100 and the other cathode active material 101. The cathode-layer conducting material 102 may comprise, for example, activated carbon, graphite, carbon black, acetylene black, cetin black, carbon fiber, a metal powder, or a combination thereof. In an embodiment, an amount of the cathode-layer conducting material 102 in the cathode layer 10 may be equal to or greater than about 1 wt % and smaller than or equal to about 50 wt %, and for example, equal to or greater than about 5 wt % and smaller than or equal to about 20 wt %, based on a total weight of the cathode layer 10.

In an embodiment, the cathode layer 10 may further include an additive, in addition to the halogen-containing sulfide catholyte 100, the other cathode active material 101, the cathode layer 10, and the conducting material 102. Examples of the additive include a binder, a filler, a dispersant, and an ion conductor.

A binder to be used in the cathode layer 10 may be, for example, polytetrafluoroethylene, polyvinylidene fluoride, or polyethylene. The binder, the filler, the dispersant, and the ion conductor, which are to be used in forming the cathode layer 10, may be any suitable materials that are used in an electrode of a lithium ion secondary battery.

### Anode Layer

Referring to FIG. 1, the anode layer 20 may include the anode active material 201, the halogen-containing sulfide catholyte 100, and an anode-layer conducting material 202. In an embodiment, the anode-layer conducting material 202 may include the same conducting material as used in the cathode-layer conducting material 102. The halogen-containing sulfide catholyte 100 may be the same as the halogen-containing sulfide catholyte 100 in the cathode layer 10. Accordingly, features related thereto, which are already described above, will not be described herein.

Compared to the other cathode active material 101 included in the cathode layer 10, the anode active material 201 may include an active material that has a low charge and discharge potential, and enables alloying with lithium, or reversibly intercalating or deintercalating lithium.

For example, the anode active material 201 may be a metal-based active material or a carbon-based active material.

Examples of the metal-based active material include metals such as lithium (Li), indium (In), aluminum (Al), tin (Zn), and silicon (Si), and alloys thereof.

For example, a lithium ion secondary battery may include lithium metal as an anode active material. For example, an anode of a lithium ion secondary battery may include lithium metal. When a lithium ion secondary battery including a lithium metal anode is used, during charging and discharging, lithium may be deposited on the surface of an anode, or lithium ions may be released from the surface of the anode by dissolution. A lithium ion secondary battery including a lithium metal anode may provide a high discharge capacity, that is, high energy density.

In an embodiment, a lithium ion secondary battery may include, as an anode active material, a lithium-alloyable metal, such as silicon (Si). In an embodiment, the anode active material of the lithium ion secondary battery may be an oxide of lithium-alloyable metal, a composite of a carbonaceous material and the oxide of lithium-alloyable metal, or the like. For example, the anode active material may include SiOx (wherein 0.5≦x≦1.5), a composite of SiOx (wherein 0.5≦x≦1.5) and carbon, or the like.

Examples of a carbonaceous active material include artificial graphite, graphite carbon fiber, resin calcined carbon, pyrolytic vapor-grown carbon, coke, mesocarbon microbeads (MCMB), furfuryl alcohol, polyacene, pitch carbon fiber, vapor grown carbon fiber, natural graphite, and non-graphitizable carbon. These anode active materials may be used alone or in combination of at least two or more thereof.

For example, in a lithium ion secondary battery including a carbonaceous anode active material, during charging and discharging, lithium may be intercalated or deintercalated between carbon layers constituting the carbonaceous anode active material.

In an embodiment, an amount of the anode active material 201 in the anode layer 20 may be equal to or greater than about 20 wt % and smaller than or equal to about 95 wt %, and for example, equal to or greater than about 50 wt % and smaller than or equal to about 90 wt %, based on a total weight of the anode layer 20. In an embodiment, an amount of the halogen-containing sulfide catholyte 100 in the anode layer 20 may be equal to or greater than about 10 wt % and smaller than or equal to about 95 wt %, and for example, equal to or greater than about 20 wt % and smaller than or equal to about 90 wt %, based on a total weight of the anode layer 20. In an embodiment, an amount of the anode-layer conducting material 202 in the anode layer 20 may be equal to or greater than about 1 wt % and smaller than or equal to about 50 wt %, and for example, equal to or greater than about 5 wt % and smaller than or equal to about 20 wt %, based on a total weight of the anode layer 20.

In an embodiment, the anode layer 20 may further include an additive, in addition to the anode active material 201, the halogen-containing sulfide catholyte 100, and the anode-layer conducting material 202. Examples of the additive include a binder, a filler, a dispersant, and an ion conducting material.

The additives used in the anode layer 20 may be the same as used in the cathode layer 10.

### Solid Electrolyte Layer

The solid electrolyte layer 30 is disposed between the cathode layer 10 and the anode layer 20, and includes the halogen-containing sulfide catholyte 100. The halogen-containing sulfide catholyte 100 may be the same as the halogen-containing sulfide catholyte 100 in the cathode layer 10. Accordingly, the solid electrolyte layer 30 will not be described in further detail herein.

Hereinbefore, the structure of the lithium ion secondary battery 1 has been described in detail.

### 3. Method of Manufacturing Lithium Ion Secondary Battery

A method of manufacturing a lithium ion secondary battery according to an embodiment of the present disclosure will be described in further detail. The lithium ion secondary battery 1 may be manufactured in such a way that the cathode layer 10, the anode layer 20, and the solid electrolyte layer 30 are separately manufactured, and then, these respective layers are stacked.

Manufacture of Solid Electrolyte

The solid electrolyte layer 30 may include a halogen-containing sulfide catholyte prepared by adding a halide to a sulfide catholyte.

First, a halogen-containing sulfide catholyte is prepared by dissolution-quench or mechanical milling.

For example, in the case of dissolution-quench, a halide is mixed with a certain ratio of Li₂S and P₂S₅, and the mixture is molded in pellets and then, reacted in a vacuum condition at a certain reaction temperature, followed by quenching, thereby completing the preparation of the halogen-containing sulfide catholyte. In an embodiment, the reaction temperature of the mixture including the halide and Li₂S and P₂S₅ may be, for example, in the range of about 400° C. to about 1,000° C., and, for example, about 800° C. to about 900° C. In an embodiment, the reaction time may be, for example, in the range of about 0.1 hours to about 12 hours, and for example, about 1 hour to about 12 hours. The quenching temperature may be, for example, 10° C. or less, for example, 0° C. or less. The quenching speed may be, for example, from about 1° C./sec to about 10,000° C./sec, and for example, from about 1° C./sec to about 1,000° C./sec.

In the case of mechanical milling, a halide is mixed with a certain ratio of Li₂S and P₂S₅, and then, the mixture is reacted by stirring using a ball mill, thereby completing the preparation of the halogen-containing sulfide catholyte. The stirring speed and stirring time for the mechanical milling are not particularly limited. However, the higher stirring speed, the higher formation speed the halogen-containing sulfide catholyte has. When the stirring time is increased, the conversion ratio of such starting materials into the halogen-containing sulfide catholyte may be increased.

Subsequently, the halogen-containing sulfide catholyte obtained by dissolution-quench or mechanical milling is heat treated at a certain temperature, and then, milled, thereby preparing the halogen-containing sulfide catholyte 100 in the form of particles.

Then, the halogen-containing sulfide catholyte 100 obtained as described above is used to form a layer by using a suitable layer-forming method, for example, blasting, aerosol deposition, cold spraying, sputtering, chemical vapor deposition (CVD), and spraying, to form the solid electrolyte layer 30. Details of the layer forming method can be determined by one of skill in the art without undue experimentation, and thus are not further elaborated on herein. In an embodiment, the solid electrolyte layer 30 may be preparing by pressurizing the halogen-containing sulfide catholyte 100 alone. In an embodiment, the solid electrolyte layer 30 may be formed by mixing the halogen-containing sulfide catholyte 100, a solvent, and one of a binder and a support and pressurizing the mixture. Herein, the binder or the support may be used to enhance the strength of the solid electrolyte layer 30 or prevent short-circuiting of the halogen-containing sulfide catholyte 100.

### Manufacture of Cathode Layer

The cathode layer 10 may be manufactured by using the following method.

First, the other cathode active material 101, the halogen-containing sulfide catholyte 100 prepared as described above, the cathode-layer conducting material 102, and various other additives are mixed, and then, a solvent, for example, water or an organic solvent is added thereto to prepare slurry or paste. Then, the slurry or paste is coated on a current collector, and then, dried and rolled to complete the preparation of the cathode layer 10. In an embodiment, the cathode layer 10 may be formed by pressurizing and rolling a mixture including the halogen-containing sulfide catholyte 100, the other cathode active material 101, and the cathode-layer conducting material 102.

### Manufacture of Anode Layer

The anode layer 20 may be manufactured in the same manner as used to manufacture the cathode layer.

In detail, the anode active material 201, the halogen-containing sulfide catholyte 100, the anode-layer conducting material 202, and various other additives are mixed, and then, a solvent, for example, water or an organic solvent is added thereto to prepare slurry or paste. Then, the slurry or paste is coated on a current collector, and then, dried and rolled to complete the preparation of the anode layer 20. In an embodiment, a thin film formed of metal lithium or a lithium ion-alloyable metal may be used as the anode layer 20.

Herein, as a current collector for the cathode layer 10 or the anode layer 20, for example, a flat or thin film which is formed of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and an alloy thereof may be used. In an embodiment, without the current collector, the mixture of additives and either the other cathode active material 101 or the anode active material 201 is roll-pressurized in the form of a pellet to form the cathode layer 10 or the anode layer 20.

### Manufacture of Lithium Ion Secondary Battery

In an embodiment, the solid electrolyte layer 30, the cathode layer 10, and the anode layer 20, prepared as described above, are stacked to manufacture the lithium ion secondary battery 1. In detail, the cathode layer 10 and the anode layer 20 are stacked with the solid electrolyte layer 30 therebetween, and the resultant structure is pressurized to manufacture the lithium ion secondary battery 1.

Hereinafter, a lithium ion secondary battery according to an embodiment will be described with reference to Examples and Comparative Examples. These examples are provided herein for illustrative purpose only, and the lithium ion secondary battery according to the present embodiment is not limited to the following examples.

### EXAMPLES

### Example 1

First, as the halogen-containing sulfide catholyte 100, LiI—Li₃PS₄ was synthesized. In an embodiment, to prepare a specific composition of 35LiI-65(0.75Li₂S-0.25P₂S₅), 0.64 grams (g) of Li₂S, 1.03 g of P₂S₅, and 1.33 g of LiI were prepared and then, mixed in a mortar. The mixed powder was sealed with a 45 mL ZrO₂ port, together with a ZrO₂ ball (φ10 mm×7, φ5 mm×20), in the argon (Ar) atmosphere, and the result was subjected to mechanical milling including rotating at a rate of 380 rpm for 10 minutes 20 times to synthesize LiI—Li₃PS₄, which is the halogen-containing sulfide catholyte 100.

Then, LiI—Li₃PS₄, which is the halogen-containing sulfide catholyte 100, and activated carbon, which is the cathode-layer conducting material 102, were mixed at a weight ratio of 80:20 in a mortar. Subsequently, the mixed powder was sealed with a 45 mL ZrO₂ port, together with a ZrO₂ ball (φ10 mm×7, φ5 mm×20), in the argon (Ar) atmosphere, and the result was rotated at a rate of 380 rpm for 10 minutes 20 times to a cathode mixture. The cathode mixture was uniformly spread in an amount of 3.6 mg, thereby completing the formation of the cathode layer 10.

LiI—Li₃PS₄, which is the halogen-containing sulfide catholyte 100, was solidified inside a 200 mg polypropylene cylinder under pressure to prepare the solid electrolyte layer 30. For use as the anode layer 20, a lithium metal film having a thickness of 30 μm was prepared.

Then, the cathode layer 10, the solid electrolyte layer 30, and the anode layer 20 were stacked in a cell container, and a pressure of 4 t/cm² was applied thereto in a uniaxial direction to prepare pellets, thereby manufacturing a test cell associated with Example 1.

### Example 2

A test cell was manufactured in the same manner as in Example 1, except that the cathode mixture further included sulfur (S) as the other cathode active material 101.

First, sulfur, which is the other cathode active material 101, was mixed with activated carbon, which is the cathode-layer conducting material 102 at a weight ratio of 74:26 in a mortar. Subsequently, the mixed powder was sealed with a 45 mL ZrO₂ port, together with a ZrO₂ ball (φ10 mm×7, φ5 mm×20), in the argon (Ar) atmosphere, and the result was rotated at a rate of 380 rpm for 10 minutes 20 times to prepare a composite of sulfur and activated carbon. Then, LiI—Li₃PS₄ was mixed with the composite, in the same amount as the composite including sulfur and activated carbon in a mortar, and sealed with a 45 mL ZrO₂ port, together with a ZrO₂ ball (φ10 mm×7, φ5 mm×20), in the argon (Ar) atmosphere, and the result was rotated at a rate of 380 rpm for 10 minutes 20 times to prepare a cathode mixture. The cathode mixture had a molar ratio of sulfur: activated carbon: LiI—Li₃PS₄=37:13:50.

### Example 3

A test cell was manufactured in the same manner as in Example 1, except that a cathode layer was prepared as below.

First, V₂O₅, which is the other cathode active material 101, LiI—Li₃PS₄, which is the halogen-containing sulfide catholyte 100, and activated carbon, which is the cathode-layer conducting material 102 were mixed at a weight ratio of 44:49:7 in a mortar. Subsequently, the mixed powder was sealed with 45 ml of ZrO₂ port, together with a ZrO2 ball (φ10 mm×7, φ5 mm×20), in the argon (Ar) atmosphere, and the result rotated at a rate of 380 rpm for 10 minutes 20 times to prepare a cathode mixture. The cathode mixture was uniformly spread in an amount of 10 mg to manufacture the cathode layer 10.

### Comparative Example 1

A test cell was manufactured in the same manner as in Example 1, except that a cathode mixture prepared by mixing Li₂ZrO₃-coated NCA (LiNi_{0.7}Co_{0.15}Al_{0.15}O₂), LiI—Li₃PS₄ synthesized as the halogen-containing sulfide catholyte 100, and activated carbon used as the cathode-layer conducting material 102 at a weight ratio of 60:35:5 was used.

### Comparative Example 2

A test cell was manufactured in the same manner as in Example 1, except that Li₃PS₄ was used instead of LiI—Li₃PS₄ synthesized as the halogen-containing sulfide catholyte 100.

### Evaluation

Charge and discharge characteristics of the test cells manufactured as described above were evaluated.

First, the test cells of Example 1 and Example 2 were charged with a constant current of 0.25 mA/cm² at a temperature of 25 [symbol] until the voltage reached the upper voltage limit of 3.1 V, and then, discharged until the voltage reached the lower voltage limit of 1.3 V. This charge and discharge cycle is performed 50 times to evaluate charge and discharge characteristics.

The discharge capacity and Coulombic efficiency of the 50^{th} cycle with respect to the first cycle was calculated, and the obtained result was evaluated as cyclic characteristics. The charge and discharge cycle was performed while the test cells were exposed to an external pressure of 3 Nm⁻², being sealed in the argon (Ar) atmosphere.

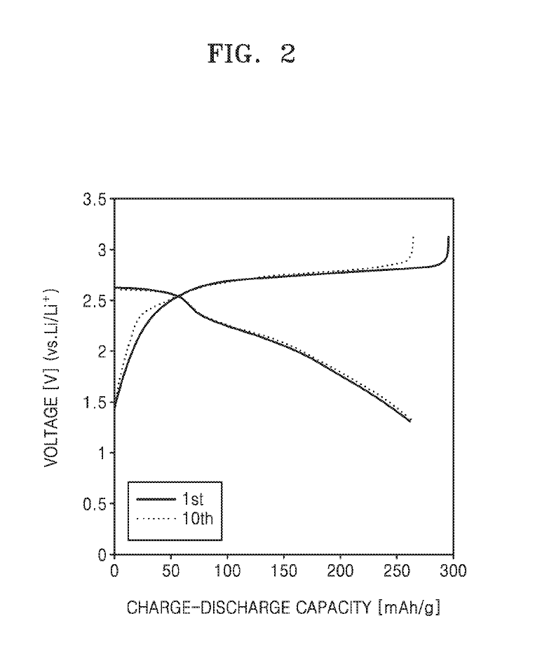

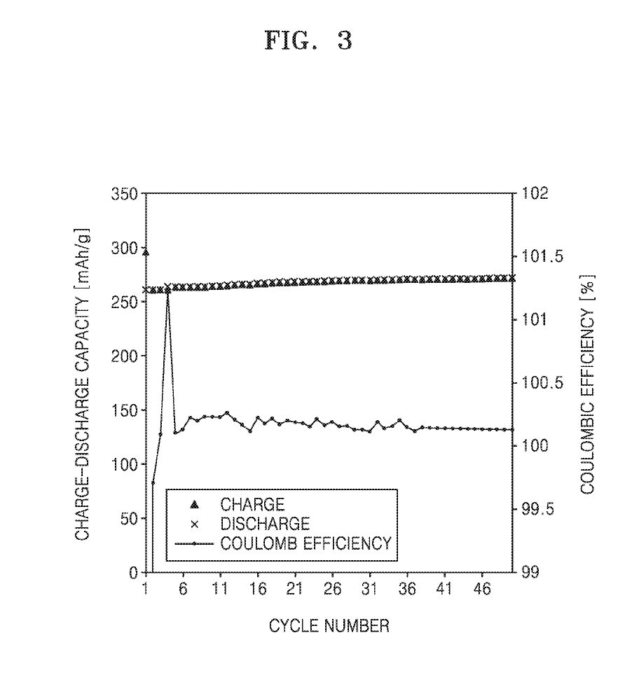

FIG. 2 shows the charge and discharge curve of the lithium ion secondary battery of Example 1, and FIG. 3 shows the graph of cyclic characteristics of the lithium ion secondary battery of Example 1.

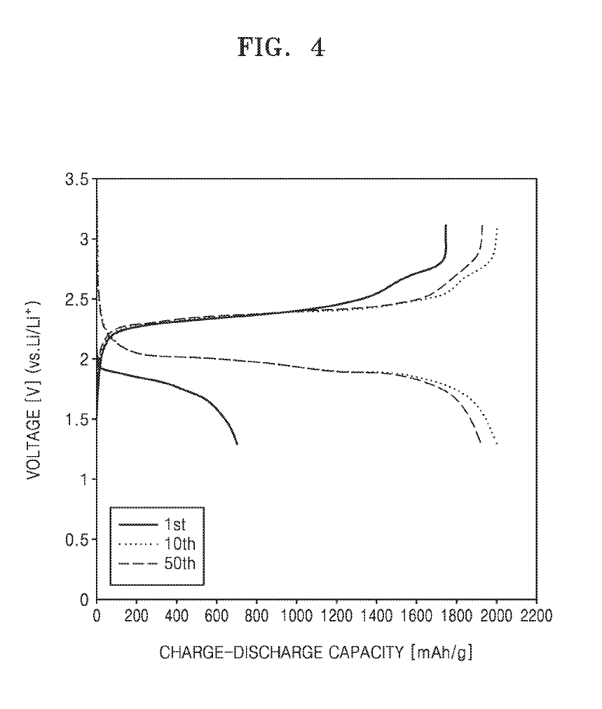

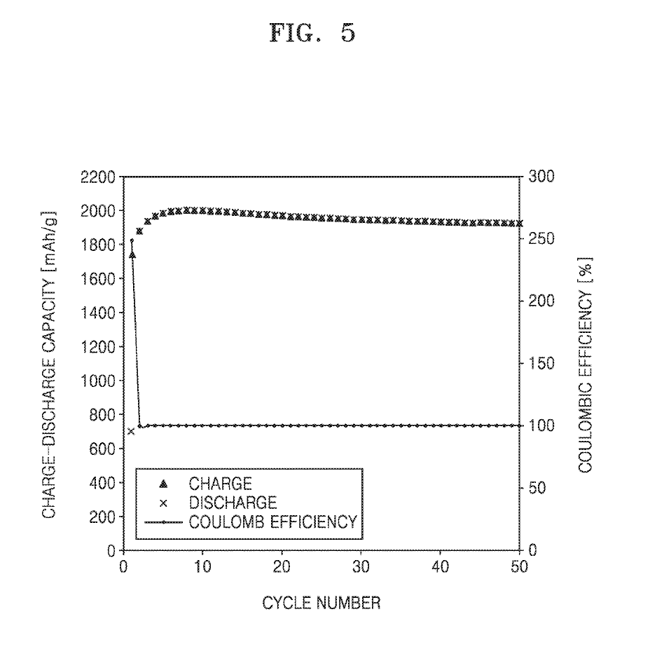

FIG. 4 shows the charge and discharge curve of the lithium ion secondary battery of Example 2, and FIG. 5 shows the graph of cyclic characteristics of the lithium ion secondary battery of Example 2.

Referring to FIGS. 2 and 3, it was confirmed that, compared to the discharge capacity (about 150 mAh/g) of Li₃PS₄ of the all-solid lithium ion secondary battery disclosed in Non-patent Document 1, the lithium ion secondary battery of Example 1 showed a higher discharge capacity and suppressed deterioration of cyclic characteristics.

This enhanced cyclic characteristics is obtained by a change of the oxidation and reduction capacity of LiI—Li₃PS₄, which is the halogen-containing sulfide catholyte 100, since Li₃PS₄ and LiI charges and discharges in a potential range of about 1.3 V to about 3.1 V (vs. Li/Li⁺) in order to show the reversible oxidation and reduction potential in the range of about 1.3 V to about 3.1 V (vs. Li/Li⁺). Accordingly, since LiI—Li₃PS₄ can act as a cathode active material, leading to an increase in the capacity of a lithium ion secondary battery.

Referring to FIGS. 4 and 5, it was confirmed that the charge and discharge capacity of the lithium ion secondary battery of Example 2 is greater than the theoretical capacity (about 1,600 mAh/g) of sulfur, cyclic characteristics do not deteriorate, and the charge and discharge are reversibly performed.

This enhanced cyclic characteristics is obtained by adding LiI—Li₃PS₄ into sulfur (S), which has a charge and discharge plateau in the potential range of 1.3 V to 3.1V (vs. Li/Li⁺), in order to show the reversible oxidation and reduction potential in the range of 1.3 V to 3.1V (vs. Li/Li⁺), thereby allowing both sulfur (S) and LiI—Li₃PS₄ can act as a cathode active material.

As a result, the lithium ion secondary battery (that is, a sulfur battery) of Example 2 shows an increase in the charge and discharge capacity.

Although the charge curve of FIG. 4 in the range of 2.5 V to 2.8 V shows an additional plateau region, it is assumed that this additional plateau is a change of charge capacity, which is originated from LiI—Li₃PS₄.

Then, at a temperature of 25° C., the test cell of Comparative Example 1 was charged with a constant current of 0.05 mA/cm² until the voltage reached the upper voltage limit of 4.0 V, and then, discharged until the voltage reached the lower voltage limit of 2.5 V. This charge and discharge cycle was performed 100 times to evaluate charge and discharge characteristics.

The discharge capacity and Coulombic efficiency of the 50^{th} cycle with respect to the first cycle was calculated, and the obtained result was evaluated as cyclic characteristics. The charge and discharge cycles were performed while the test cells were exposed to an external pressure of 3 Nm⁻², being sealed in the argon (Ar) atmosphere.

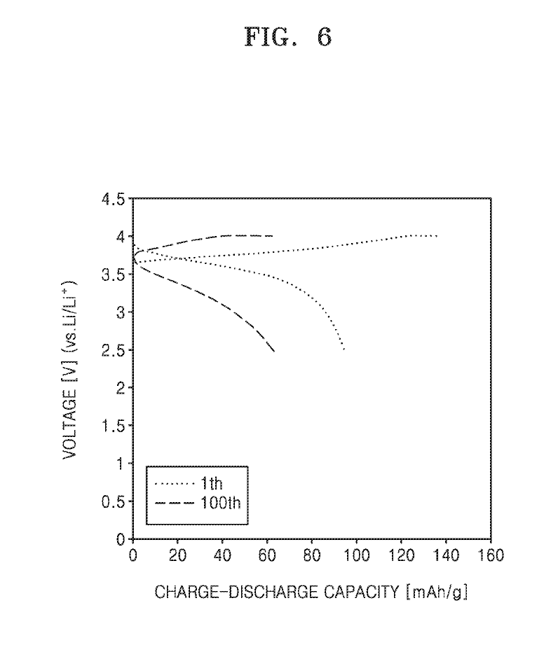

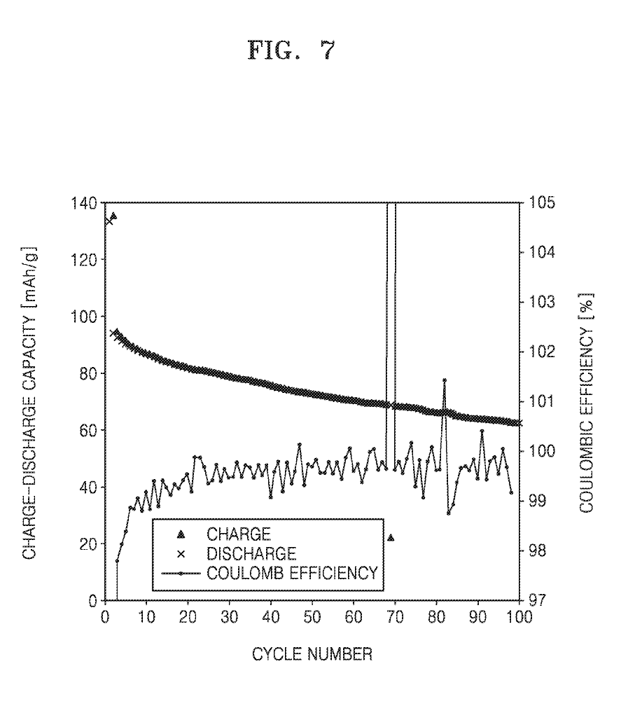

FIG. 6 shows the charge and discharge curve of the lithium ion secondary battery of Comparative Example 1, and FIG. 7 shows the graph of cyclic characteristics of the lithium ion secondary battery of Comparative Example 1.

Referring to FIGS. 6 and 7, the lithium ion secondary battery of Comparative Example 1 shows only a capacity of a cathode, that is, NCA only (about 132 mAh/g), and cyclic characteristics were not good. This is because NCA has an average charge and discharge potential of 3.6 V to 3.7 V and the average charge and discharge potential of NCA does not overlap the charge and discharge potential of LiI—Li₃PS₄, and thus, LiI—Li₃PS₄ does not act as a cathode active material.

Next, the test cells of Example 3 and Comparative Example 2 were charged with a constant current of 0.70 mA/cm² at a temperature of 25 [symbol] until the voltage reached the upper voltage limit of 4.0 V, and then, discharged until the voltage reached the lower voltage limit of 1.5 V. For each, this charge and discharge cycle is performed 100 times to evaluate charge and discharge characteristics.

The discharge capacity and Coulombic efficiency of the 100^{th} cycle with respect to the first cycle was calculated, and the obtained result was evaluated as cyclic characteristics. The charge and discharge cycle was performed while the test cells were exposed to an external pressure of 3 Nm⁻², being sealed in the argon (Ar) atmosphere.

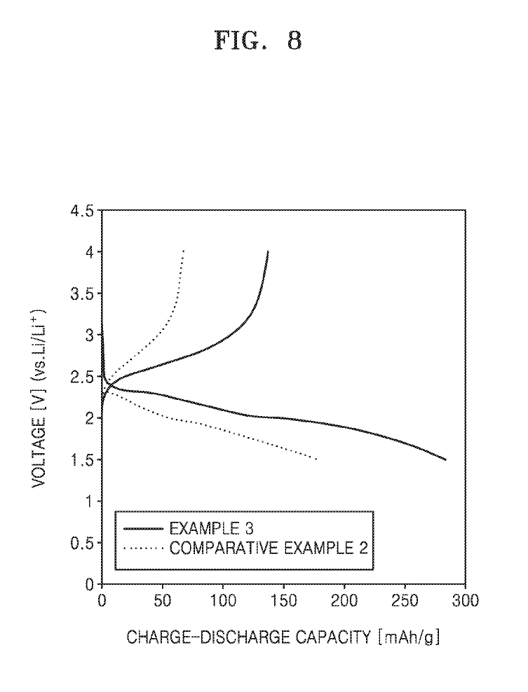

FIG. 8 shows the charge and discharge curve of the lithium ion secondary batteries of Example 3 and Comparative Example 2.

Referring to FIG. 8, it was confirmed that Example 3 has a greater charge and discharge capacity than Comparative Example 2. From this result, it was confirmed that when charging and discharging are performed in the voltage range of 1.3 V to 3.1 V (vs. Li/Li⁺), as a cathode active material, LiI—Li₃PS₄ shows a higher capacity than Li₃PS₄.

From these evaluation results, it was confirmed that, since the lithium ion secondary battery 1 includes the cathode layer 10 including the halogen-containing sulfide catholyte 100 and the cathode-layer conducting material 102, the halogen-containing sulfide catholyte 100 may show oxidation and reduction capacity, leading to a higher discharge capacity.

In detail, since the lithium ion secondary battery 1 is driven in the charge and discharge potential of 1.3 V to 3.1 V (vs. Li/Li⁺), LiI—Li₃PS₄, which is the halogen-containing sulfide catholyte 100, may show the high oxidation and reduction capacity in the cathode layer 10. Accordingly, the lithium ion secondary battery 1 may have high discharge capacity.

As explained in connection with Example 2, the lithium ion secondary battery 1 may be a sulfur battery since the cathode layer 10 thereof includes the halogen-containing sulfide catholyte 100 and the other cathode active material 101, which is sulfur. Since sulfur has the reversible oxidation and reduction potential of 1.3 V to 3.1 V (vs. Li/Li⁺), the sulfur battery may show a charge and discharge plateau within this range. Accordingly, since LiI—Li₃PS₄, which has a reversible oxidation potential range overlapping that of sulfur, is used as the halogen-containing sulfide catholyte 100, LiI—Li₃PS₄ may perform as a cathode active material. Thus, the charge and discharge capacity of the sulfur battery may be further increased.

As described above, the halogen-containing sulfide catholyte 100 is included in the anode layer 20 and the solid electrolyte layer 30. However, the present disclosure is not limited to this embodiment. For example, each of the anode layer 20 and the solid electrolyte layer 30 may not include the halogen-containing sulfide catholyte 100, or may include any the sulfide solid electrolyte.

Lithium ion secondary batteries according to embodiments of the present disclosure may have high charge and discharge capacity.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A lithium ion secondary battery comprising:
a cathode layer comprising
at least a halogen-containing sulfide catholyte comprising a sulfide catholyte and a halide, and
a conducting material;
a solid electrolyte layer; and
an anode layer,
wherein the halogen-containing sulfide catholyte in the cathode layer can be reversibly oxidized and reduced.

2. The lithium ion secondary battery of claim 1, wherein the halogen-containing sulfide catholyte showing the oxidation and reduction capacity has a reversible oxidation and reduction potential of about 1 Volt to about 3.5 Volts vs. Li/Li⁺.

3. The lithium ion secondary battery of claim 1, wherein the halogen-containing sulfide catholyte has a greater discharge capacity than a discharge capacity of the sulfide catholyte.

4. The lithium ion secondary battery of claim 1, wherein the lithium ion secondary battery has a discharge capacity of 200 milliampere hours per gram or more after being charged at a voltage of 1.3 Volts vs. Li/Li⁺.

5. The lithium ion secondary battery of claim 1, wherein the halogen-containing sulfide catholyte has an average particle diameter of about 0.01 μm to about 30 μm.

6. The lithium ion secondary battery of claim 1, wherein an amount of the halogen-containing sulfide catholyte is in the range of about 30 weight percent to about 95 weight percent, based on a total weight of the cathode layer.

7. The lithium ion secondary battery of claim 1, wherein a capacity retention of the lithium secondary ion battery after 50 cycles of charging and discharging in a voltage range of about 1.3 Volts to about 3.1 Volts vs. Li/Li⁺ is 95% or more.

8. The lithium ion secondary battery of claim 1, wherein a coulombic efficiency of the lithium secondary ion battery after 50 cycles of charging and discharging in the voltage range of about 1.3 Volts to about 3.1 Volts vs. Li/Li⁺ is 95% or more.

9. The lithium ion secondary battery of claim 1, wherein the lithium ion secondary battery does not comprise another cathode active material which is different from the halogen-containing sulfide catholyte.

10. The lithium ion secondary battery of claim 1, wherein the cathode layer further comprises another cathode active material which is different from the halogen-containing sulfide catholyte.

11. The lithium ion secondary battery of claim 10, wherein the halogen-containing sulfide catholyte has a reversible oxidation-reduction potential range that partially or completely overlaps a reversible oxidation-reduction potential range of the other cathode active material.

12. The lithium ion secondary battery of claim 10, wherein the reversible oxidation-reduction potential range of the other cathode active material at least partially overlaps a reversible oxidation-reduction potential range of the halogen-containing sulfide catholyte in the range of 1 Volts to 3.5 Volts vs. Li/Li⁺.

13. The lithium ion secondary battery of claim 10, wherein the reversible oxidation-reduction potential of the other cathode active material is 3.5 Volts vs. Li/Li⁺ or less.

14. The lithium ion secondary battery of claim 10, wherein the reversible oxidation-reduction potential of the other cathode active material is 2.5 Volts vs. Li/Li⁺ or less.

15. The lithium ion secondary battery of claim 10, wherein, a combination of the other cathode active material and the halogen-containing sulfide catholyte has a greater discharge capacity than a discharge capacity of the other cathode active material.

16. The lithium ion secondary battery of claim 10, wherein the other cathode active material comprises LiMO₄ wherein M is Fe, Mn, Ni, or Cu, Li_{4/3}Ti_{5/3}O₄, Bi₂O₃, Bi₂Pb₃O₅, CuO, V₆O₁₃, LiV₆O₁₃, NbSe₃, LiNbSe₃, TiS₂, FeS, FeS₂, CuS, Ni₃S₂, LiTiS₂, LiMoS₂, S, Li₂S, V₂O₅, or a combination thereof.

17. The lithium ion secondary battery of claim 10,
wherein the other cathode active material is sulfur, and
wherein the lithium ion secondary battery has a discharge capacity of 1,700 milliampere hours per gram or more charged to a cut-off voltage of 1.3 Volts vs. Li/Li⁺.

18. The lithium ion secondary battery of claim 10, wherein a capacity retention after 50 cycles of charging and discharging in the voltage range of 1.3 Volts to about 3.1 Volts vs. Li/Li⁺ is 95% or more.

19. The lithium ion secondary battery of claim 10, wherein a coulombic efficiency after 50 cycles of charging and discharging in the voltage range of 1.3 Volts to about 3.1 Volts vs. Li/Li⁺ is 95% or more.

20. The lithium ion secondary battery of claim 1, wherein the sulfide catholyte comprises Li₂S—P₂S₅, Li₂S—P₂S₅—Li₂O, Li₂S—SiS₂, Li₂S—SiS₂—B₂S₃, Li₂S—B₂S₃, Li₂S—P₂S₅—ZₘSₙ wherein m and n are each an integer and Z is one of Fe, Zn, Ge and Ga, Li₂S—GeS₂, Li₂S—SiS₂—Li₃PS₄, and Li₂S—SiS₂—LiₚMO_{q} wherein p and q are each a positive number and M is P, Si, Ge, B, Al, Ga, or In, or a combination thereof.

21. The lithium ion secondary battery of claim 1, wherein the sulfide catholyte is pLi₂S-(1-q)5P₂S₅wherein 0.50≦p≦0.90.

22. The lithium ion secondary battery of claim 1, wherein the sulfide catholyte is 0.75Li₂S-0.25P₂5₅.

23. The lithium ion secondary battery of claim 1, wherein the halide is LiX, wherein X comprises Cl, Br, I, or a combination thereof.

24. The lithium ion secondary battery of claim 1, wherein the halogen-containing sulfide catholyte is aLiX-(100-a)(0.75Li₂S-0.25P₂S₅), wherein 0<a<50, and X is Cl, Br, or I.

25. The lithium ion secondary battery of claim 1, wherein the halide is LiI.

26. The lithium ion secondary battery of claim 1, wherein the halogen-containing sulfide catholyte is 35LiI-65(0.75Li₂S-0.25P₂S₅).
